(19) United States
(12) Patent Application Publication
(10) Pub. No.: US 2021/0285583 A1
(43) Pub. Date: Sep. 16, 2021

(54) BALL JOINT FOR PIPE CONNECTION AND PIPE CONNECTION

(71) Applicant: LEO DYNAMISCHE INVESTERING B.V., Amsterdam (NL)

(72) Inventor: Barend Jan DE WIJN, EA Haarlem (NL)

(21) Appl. No.: 16/467,448

(22) PCT Filed: Dec. 6, 2017
(86) PCT No.: PCT/NL2017/050818

§ 371 Date: Jun. 6, 2019

(30) Foreign Application Priority Data
Dec. 6, 2016 (NL) 2017939

(51) Int. Cl. F16L 37/00; F16L 37/20; F16L 37/52; F16L 37/62

(52) U.S. Cl. CPC F16L 37/002; F16L 37/62; F16L 37/52; F16L 37/20

(57) ABSTRACT

Disclosed is a ball joint for connecting two floating pipes, the joint including an inner shell part, an outer shell part and a clamp with segments that are moveable in a common plane between an open position in which at least one of the shell parts is moveable into and out of the clamp, and a clamping position in which movement of both shell parts along the longitudinal centre lines is prevented. The ball joint is provided with a remote controlled actuator for driving movement of the segments between the open and closed position, without requiring nearby personnel to keep the shell parts aligned. Also disclosed is such a clamp and to a method of connecting such a ball joint to two pipes.

### FIELD OF THE INVENTION

The present invention relates to a ball joint for a floating pipe connection, said ball joint comprising an inner shell part and an outer shell part which each define a respective longitudinal centre line and are rotatable in relation to one another between an aligned position in which the longitudinal centre lines coincide, and a rotated position in which the longitudinal centre lines are at an angle to each other which differs from zero, wherein said outer shell part is adapted for surrounding said inner shell part in a sealing manner with the inner shell part and outer shell part together enclosing a passage which extends from an opening in the inner shell part at one side of the ball joint to an opening in the outer shell part at another side of the ball joint. The ball joint is particularly suitable for connecting two pipes or hoses at sea or on a lake where the pipes/hoses and the ball joint connecting these are floatingly supported by a floatation body, as is often case for floating dredging hoses that are used in dredging operations.

### BACKGROUND ART

A joint of this type is known from WO 2012/002805 A1 by applicant. When mounting the ball joint, the inner and outer shell part are each attached to a respective pipe, generally by welding, and the outer shell part is then slid over the inner shell part to a position in which it surrounds the inner shell part in a sealing manner. Subsequently, in order to close the ball joint, a yoke is rotated around the longitudinal centre line of the inner shell part so that it engages a bush which is arranged around the outer shell part. The yoke and bush together allow the rotation of the shell parts between the aligned position and the rotated position but prevent translational movement of the yoke relative to the bush, in this manner also preventing translational displacement between the inner shell part and the outer shell part.

A drawback of the known ball joint is that personnel usually has to manually align and turn the yoke in order to ensure correct engagement of the bush when the yoke is rotated. The close proximity of personnel to the yoke and bush is highly undesirable as hands or fingers may become trapped between moving parts of the joint, which may result in severe injury. When the yoke is rotated to close or open the joint, different parts of the ball joint are moved relative to each other.

During connection of two pipes to each other at sea using the known ball joint, in particular when the pipes and/or joint are floatingly supported, waves and rough weather conditions also cause parts of the ball joint to move relative to each other, thus posing risk of injury to nearby personnel .

The present invention seeks to provide a ball joint which reduces the risk of injury to personnel during connection of the ball joint to two pipes.

It is a further object of the present invention to provide a ball joint which facilitates connection of two pipes that are floatingly supported, e.g. at sea, and which are moveable relative to each other, under a variety of weather conditions.

### SUMMARY OF THE INVENTION

To this end, according to a first aspect, the present invention provides a ball joint for a floating pipe connection, comprising: an inner shell part and an outer shell part which each define a respective longitudinal centre line and are rotatable in relation to one another between an aligned position in which the longitudinal centre lines coincide, and a rotated position in which the longitudinal centre lines are at an angle to each other which differs from zero, wherein the outer shell part is adapted for surrounding said inner shell part in a sealing manner with the inner shell part and outer shell part together enclosing a passage which extends from an opening in the inner shell part at one side of the ball joint to an opening in the outer shell part at another side of the ball joint; a clamp comprising two or more substantially rigid segments moveable between a clamping position in which they clamp the inner and outer shell part such that movement of the inner shell part relative to the outer shell part along either longitudinal centre line is substantially prevented while allowing said rotation of the inner shell part relative to outer shell part, and an open position in which one of said shell parts is moveable along its longitudinal centre line into and out of the clamp; wherein said two or more segments are pivotably connected in series, said series comprising a first segment and an different last segment, wherein said segments are moveable relative to each other in a common plane between the open and the clamping position; wherein said ball joint is further provided with a remote controlled actuator arranged for driving movement of the two or more segments within said common plane between said clamping position and said open position.

Due to the decrease in inner diameter of the clamp when the segments are moved from the open position to the clamping position, both the inner shell part and the outer shell part are forced into alignment with the clamping segments during said movement. As a result, reliable clamping of the two shell parts by the clamp is achieved without requiring additional manual alignment by personnel during said movement, even when the inner and/or outer shell parts are fixed to corresponding pipe ends. The actuator which is arranged for driving movement of the segments can be remotely controlled by personnel from a safe distance, e.g. from a distance of at least 2 m, preferably from a distance of at least 5 m from the clamp. Thus, no persons have to be in the immediate vicinity of the ball joint during closing and/or opening thereof, substantially reducing the risk of injury. The ball joint according to the invention, which may weigh 5000 kg or more, is particularly suitable for connecting floating dredging hoses to each other, for instance hoses having outer diameters of about 1 m or more and/or wherein the hoses are used to transport sand- and rock-carrying water and/or sludge during dredging operations. The clamp is preferably adapted for clamping the inner and outer shell part substantially without deformation of the either shell part, allowing substantially rigid the inner and outer shell parts to be used which substantially do not deform during clamping.

In an embodiment said two or more segments comprise an intermediate segment that is pivotably connected on one end to the first segment and pivotably connected at an opposite end to the last segment. The additional intermediate segment allows a more even distribution of force by the segments on the inner and outer shell part during movement to the clamping position. Preferably the clamp has three segments in total, so that the segments may be moved between the open and clamping position by simply moving those ends of the first and last segment that are not connected to the intermediate segment relative to each other.

In an embodiment said series of segments, when in the open position, is translatable in the common plane and relative to the shell parts when one or both of the shell parts are partially arranged within said plane. Besides individually rotating within said plane, the segments of the clamp can thus be translated together within the common plane, to facilitate positioning of the inner and/or outer segment into or within the clamp, e.g. in a direction perpendicular to the longitudinal centre axis or axes of said shell part(s).

In an embodiment said two or more segments are pivotably connected in series by means of hinges, each hinge connecting two segments in said series, wherein at least one of said hinges is moveable in said plane relative to said inner shell part and/or said outer shell part when the segments are in the open position and one or both of the shell parts are partially arranged within said plane (C). Because at least one of the hinges that connects two segments of the series to each other is moveable relative to the inner and/or outer shell part when the segments are in the open position, positioning the clamp around the shell parts is facilitated. Moreover, the extent to which the segments need to open in order to be able to allow the shell parts to be inserted in the clamp, is reduced, in particular when compared to a clamp in which all hinge points are fixedly connected with respect to the inner and/or outer shell part. Preferably all of the hinges are moveable in within the common plane relative to the inner and/or outer shell part when the segments are in the open position.

In an embodiment the actuator is an fluid powered actuator, such as an hydraulically powered or pneumatically powered actuator, comprising one or more ports for connection to a fluid supply for powering the actuator to rotate said segments between said clamping position and said open position. This allows an actuator to be used that is of a particularly simple construction. By connecting the actuator to an external fluid supply, such as a pump for providing pressurized water, oil or air, that is spaced apart from the clamp, the actuator can be controlled and powered from a distance. The fluid supply may for instance be arranged on a floating structure, such as a dinghy, or on another structure that is separate from the pipe connection, and be connected to the one or more ports of the actuator via a hose or the like. Though the fluid supply may be adapted for using oil as the fluid for powering the actuator, preferably the fluid for powering the actuator is water or air in order to minimize risk to the environment if some of the fluid is spilled. The water or air may conveniently be taken from the immediate environment of the fluid supply, e.g. from the sea or lake on which the pipe connection floats, or from the air surrounding the fluid supply. In an embodiment the actuator is adapted to be controlled from a distance of at least 2 m, preferably at least 5 m, from said clamp. This allows the clamp to be opened and closed without risk of injury to persons.

In an embodiment the inner shell part has a spherical outer surface for abutting against a matching inner surface of the outer shell part, each of said segments comprising a further matching inner surface for abutting against the spherical outer surface of the inner shell part, wherein said matching inner surface and said further matching inner surfaces are adapted for allowing rotation of the inner shell part relative thereto when the segments are in the clamping position while preventing axial movement of the inner shell part along its longitudinal centre line. This rotation at least allows a variation in the angle between the longitudinal axes of the inner shell part and the outer shell part but may also comprise a rotation of the inner shell part around its longitudinal centre line. The inner shell part is held in place by the further matching inner surfaces of the segments which are spaced apart from the matching surface of the outer shell part along the longitudinal centre line of said outer shell part. The inner shell part may thus be reliably held clamped by the segments, without deforming the outer shell part.

In an embodiment each of the segments is provided on its inner side with a guide surface for guiding the inner shell part into the clamp, wherein said guide surface slopes from a free distal end of the segment towards the centre axis of the clamp and is completely spaced apart from the segment's inner surface that is adapted for abutting against the spherical outer surface, wherein the free distal ends of two segments, along a line through the centre axis of the clamp and when the clamp is in the clamping position, are at a distance from each other which is greater than a maximum outer diameter of spherical outer surface. As the guide surfaces are completely spaced apart from the segment's inner surface which comes into contact with the spherical outer surface, pinching of the guide surfaces when the clamp is moved to the clamping position is avoided. The guide surfaces preferably comprise an elastomer material such as nitrile butadiene rubber. As the guide surface are spaced apart from the inner surface during rotation of the inner shell part relative to the outer shell part, the guide surfaces are further prevented from becoming lodged between the outer spherical surface and the inner surfaces of the segments, or otherwise hindering rotation of the shell parts, e.g. by making friction contact with the outer spherical surface once the clamp is closed.

In an embodiment the inner shell part is provided with a flange having a circumferential edge for abutting a stop surface of one of said segments when the inner shell part is in a position of maximum rotation with respect to the outer shell part, wherein the stop surface extends between the segment's guide surface and a distal edge of the segment's inner surface. Thus, in any position of rotation of the inner shell part relative to the outer shell part when the clamp is in the clamping position, the circumferential edge of the flange is arranged for contacting the stop surface, without contacting any of the guide surfaces. The flange protects a pipe that is attached to the inner shell part from being damaged when the inner shell part is in the position of maximum rotation. In turn, in this embodiment, the guide surface is prevented from becoming pinched between the circumferential edge and the stop surface.

In an embodiment the guide surfaces of the segments comprise or are made from an elastic material. The guide surfaces are thus substantially more flexible than the inner shell part so that upon contact of the inner shell part with the guide surfaces damage to the inner shell part is prevented. Preferably, the elastic material has a Young's modulus that is at least 1500 times smaller than the Young's modulus of the material the inner shell part is made of. For instance, when the guide surfaces are made from an elastomer and the inner shell part is made from steel, the Young's modules of the guide surfaces may be in the range of 80-100 Megapascal, and the Young's modulus of the inner shell part may be in the range of 190-220 Gigapascal. Preferably, the inner surfaces of the segments that are in contact with the outer surface of the inner shell part are made from a metal or metal alloy.

In an embodiment, the elastic material comprises or consists of an elastomer having a

Shore A hardness in the range of 70 to 100, measured for instance according to ISO 7619-1:2010 90 Shore A NBR (Nitrile butadiene rubber) has been found particularly suitable as it is oil and seawater resistant, is resistant to abrasion and has good shock absorption properties. Moreover, 90 Shore A NBR can be used at least within a temperature range of −40 to 120 degrees Celsius. In an embodiment, each guide surface, when seen in cross-sectional view through a plane parallel to and through the centre axis of the clamp, has a maximum thickness in a plane normal to said centre axis which is two times or more a maximum thickness of the inner shell part along any plane normal to the longitudinal axis of said inner shell part. This helps to prevent damage to the guide surface when in guiding contact with the inner shell part.

In an embodiment, each guide surface, when seen in cross-sectional view through a plane parallel to and through the centre axis of the clamp, extends along a substantially circle-segment shaped contour which extends over an arc of at least 90 degrees. This helps prevent damage to the distal end of the inner shell part as the inner shell part is moved into the clamp. The radius of the circle segment shaped contour is typically larger than the radius of the spherical outer surface of the inner shell part.

In an embodiment each guide surface, when seen in cross-sectional view through a plane parallel to and through the centre axis of the clamp, increases in thickness in a direction away from the free end of the corresponding segment. In this manner, the distance over which the guide surface can be deflected in a direction normal to the central axis decreases in a direction away from the free end.

In an embodiment, the guide surfaces are adapted for spacing the insertion end of the inner shell part, i.e. the distal end of the inner shell part opposite to the flange, apart from the stop surface and distal edge as the inner shell part is inserted into the outer shell part along a direction parallel to the centre axis of the clamp. In an embodiment, the guide surfaces each have a length along the centre axis of the clamp that is at least one third, preferably at least half, of the length of the inner shell part along its longitudinal axis. The guide surfaces thus extend over a significant length in front of the outer shell part, allowing the inner to be inserted into the outer shell part and to be aligned therewith from a distance of the ball joint. In an embodiment the clamp further comprises a latch for keeping the segments in the clamping position. Thus, the actuator does not have to be constantly powered in order to keep the segments in the clamping position.

In an embodiment the latch comprises a first arm and a second arm, wherein said first arm is pivotably connected at a first side to said first segment and pivotably connected at a second side to a first side of said second arm, wherein said second arm is pivotably connected at a second side to said last segment, and wherein said actuator is arranged for rotating said first arm relative to said second arm to move the segments between said clamping position and said open position. The latch further helps to more evenly distribute the forces exerted by the clamp on the inner shell part and outer shell part when the segments are moved to the clamping position. The latch also defines the degree to which the segments can be brought together, i.e. defines the clamping position of all segments, thus preventing the segments from clamping the shell parts too tightly or not tightly enough. Additionally, as the latch and the segments of the clamp form a loop both in the open position and in the clamping position, once the clamp has been arranged around a pipe or shell part it can only be removed by moving the clamp axially along the pipe or shell part. In an embodiment the actuator is a detachable actuator, and the first and/or the last segment is adapted for detachably connecting said actuator thereto. For instance, prior to using the actuator for driving movement segments, one end of the actuator may be detachably connected to the first or last segment by means of a bolt and nut connection, and another end of the actuator may be detachably connected to the latch by means of another bolt and nut connection. Once the segments have been fixed in the clamping position, the actuator can be detached. Optionally the actuator can be reattached at a later time if the actuator is used to drive movement of the segments from the clamping position to the open position.

In an embodiment the inner shell part or said outer shell part, preferably only the outer shell part, is provided with a flange and the segments each comprise an accommodating section for accommodating a portion of said flange when the segments are in the clamping position to substantially prevent axial movement of the flange relative to said accommodating sections, and wherein said segments comprise an abutment surface adapted for abutting said flange to prevent the flange, when arranged in the clamp, from moving past the accommodating sections when the segments are in the open position. Thus, when the segments are in the open position the flange can be moved no further into the clamp than to a position in which it abuts the abutment surface or surfaces of the segments. In this position the other shell part can be inserted into the clamp and arranged such that the outer shell part surrounds the inner shell part in a sealing manner, after which the segments can be moved to the clamping position.

In an embodiment the clamp is further provided with a limiting mechanism adapted for limiting movement of the segments to the open position in such a manner that in the open position the clamp cannot be moved past the flange. Once the flange has been arranged in the clamp such that it abuts the abutment surface or surfaces, the limiting mechanism prevents the clamp from being moved off the flange while still allowing the other shell part to be inserted into the clamp when the segments are in the open position. In an embodiment the limiting mechanism comprises a circumferential limiting surface arranged around and attached to the inner or outer shell part, and further comprises one or more stop elements attached to said segments and arranged in a same plane as said circumferential limiting surface, wherein movement of the segments to the open position is limited by said stop elements when said stop elements abut said circumferential limiting surface. The stop elements that are attached to the segments can, when the segments are in the open position, translate and/or rotate within the plane in which said circumferential limiting surface extends. Preferably the stop elements are adapted to be attached to the segments after the shell part that is provided with the flange has been inserted into the clamp. For instance, the stop elements may be threaded bolts that are screwed into corresponding threaded holes in the segments after the shell part with the flange has been inserted into the clamp.

In an embodiment, said segments are substantially free to rotate around the flange when in the open position. That is, when in the open position the segments can rotate at least 360 degrees around an axis normal to the common plane, independent of an orientation of the inner shell part and/or the outer shell part.

According to a second aspect, the present invention provides a clamp for a ball joint comprising an inner shell part and an outer shell part which each have a longitudinal centre line, in particular for a ball joint as described herein. The clamp according to the invention comprises two or more substantially rigid segments connected in series, said series comprising a first segment and an different last segment, wherein said segments are moveable relative to each other in a common plane between a clamping position in which movement of the inner shell part relative to the outer shell part along either longitudinal centre line is substantially prevented while allowing rotation of the inner shell part relative to the outer shell part, and an open position in which one of said shell parts is moveable along its longitudinal centre line into and out of the clamp. Preferably, the clamp is provided with a remote controlled actuator arranged for driving movement of the two or more segments within said common plane between said clamping position and said open position.

According to a third aspect, the present invention provides a method of connecting a ball joint according to any one of the preceding claims to a first pipe and a second pipe, said method comprising the steps of:

moving the segments of the clamp to an open position in which both the inner shell part and the outer shell part can be inserted into the clamp;

arranging said first pipe, with the outer shell part attached to an end thereof, such that said outer shell part is arranged in the clamp;

arranging said second pipe, with the inner shell part attached to an end thereof, such that the inner shell part is arranged in the clamp, with an outer surface of the inner shell part contacting an inner surface of the outer shell part; and

remote controlling the actuator to move the segments to the clamping position. Remote controlling herein means that the actuator is controlled while no persons are in the immediate vicinity of the ball joint, e.g. no persons are with a distance of 2 m, or 5 m of the ball joint, when the actuator drives movement of the segments. The risk of injury to personnel is thus substantially reduced.

In an embodiment said remote controlling comprises supplying fluid, preferably hydraulic fluid in the form of water, to a port of said actuator, for moving said segments between the open and clamping position.

In an embodiment said supplying of fluid is performed by means of a pump that is spaced apart from the ball joint on a floating platform, such as a boat. Preferably the pump is a water pump or air pump arranged on the deck of a dinghy or similarly sized boat, which is easily manoeuvrable on the water.

In an embodiment the method further comprises, just after arranging the first pipe such that the outer shell part is arranged in the clamp, attaching one or more stop elements to the segments of the clamp for limiting the extent to which the segments can open, such that the outer shell part cannot be moved out of the clamp. This may be done while the position of the first pipe and ball joint is substantially fixed, e.g. when the first pipe and ball joint are supported on land, or are both supported on a common floating platform. The first pipe, with the outer shell part fixed thereto and the clamp arranged around the outer shell part, may then be placed in or on the water in a position where the inner shell part that is fixed to the second pipe can be inserted in the clamp.

According to a fourth aspect, the present invention provides a pipe connection assembly comprising a ball joint according to the invention, and further comprising: a first pipe with an end to which the outer shell part is attached and wherein said clamp is arranged around said outer shell part. The pipe, ball joint and outer shell part of this assembly can be assembled on land or on a vessel, after which the assembly can be placed in or on the water in a position where the inner shell part that is fixed to the second pipe can be inserted in the clamp. This allows very fast connection of pipes on sea and lakes, substantially without risk of injury to personnel.

In an embodiment the assembly further comprises a second pipe with an end to which the inner shell part is attached; wherein said inner shell part is arranged at least partially within the outer shell part.

In an embodiment the assembly further comprises a fluid supply spaced apart from the clamp by a distance of at least 2 m, preferably at least 5 m, wherein said actuator is a fluid powered actuator with one or more ports for connection to said fluid supply for powering the remote controlled actuator to rotate said segments between said clamping position and said open position, wherein said fluid supply is connected via one or more fluid conduits, such as a hose, to the one or more ports of the actuator. The fluid supply is preferably provided on a vessel, e.g. a dinghy, which can be manoeuvred relative to two floating pipes and be spaced apart therefrom.

In summary, the present invention relates to a ball joint for connecting two floating pipes, said joint comprising an inner shell part, an outer shell part and a clamp with segments that are moveable in a common plane between an open position in which at least one of the shell parts is moveable into and out of the clamp, and a clamping position in which movement of both shell parts along the longitudinal centre lines is prevented. The ball joint is provided with a remote controlled actuator for driving movement of the segments between the open and closed position (i.e. clamping positing), without requiring nearby personnel to keep the shell parts aligned. The invention further relates to such a clamp and to a method of connecting such a ball joint to two pipes.

Short description of drawings

The present invention will be discussed in more detail below, with reference to the attached drawings, in which:

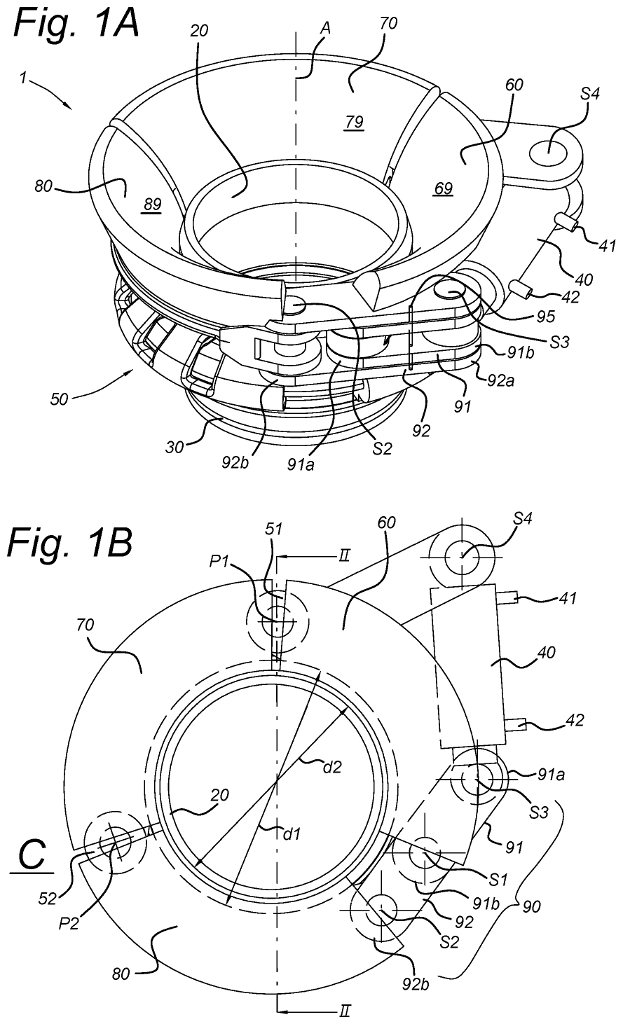

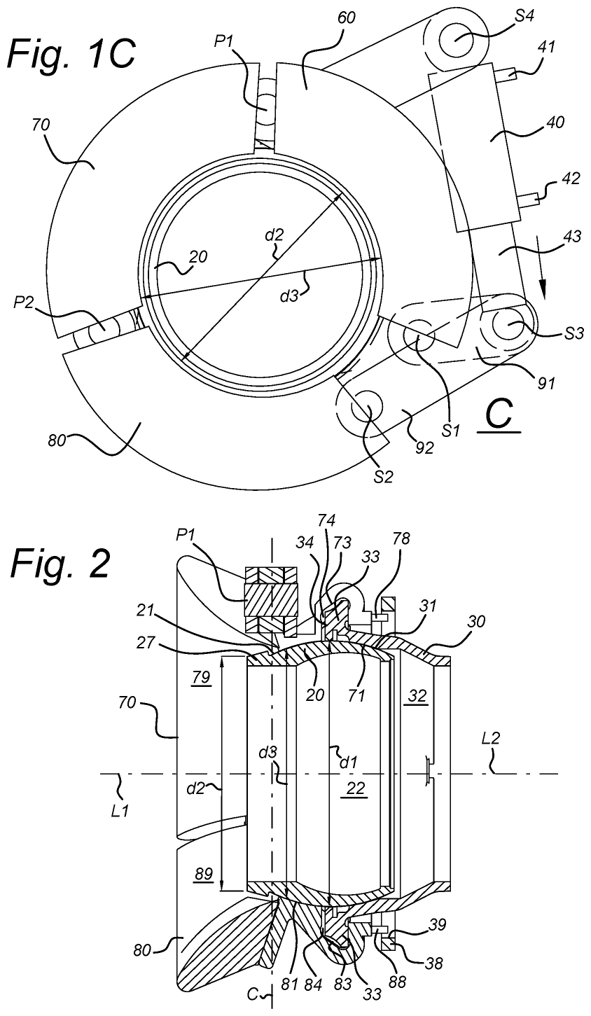

FIG. 1A shows a view of a ball joint according to the present invention;

FIG. 1B and 10 respectively show a top view and a front view of the same ball joint in a clamping and open position;

FIG. 2 shows a cross-sectional view through line Il-Il in FIG. 1B;

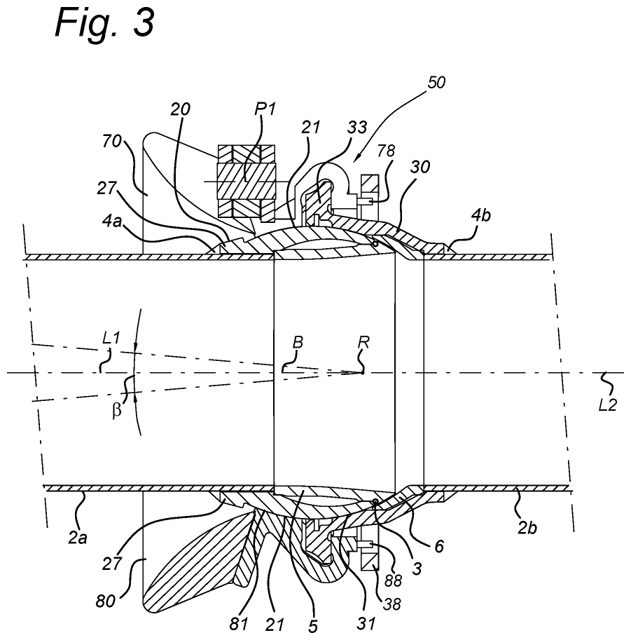

FIG. 3 shows the ball joint according to the invention, connecting two pipes and wherein liners are provided on the interior of the joint;

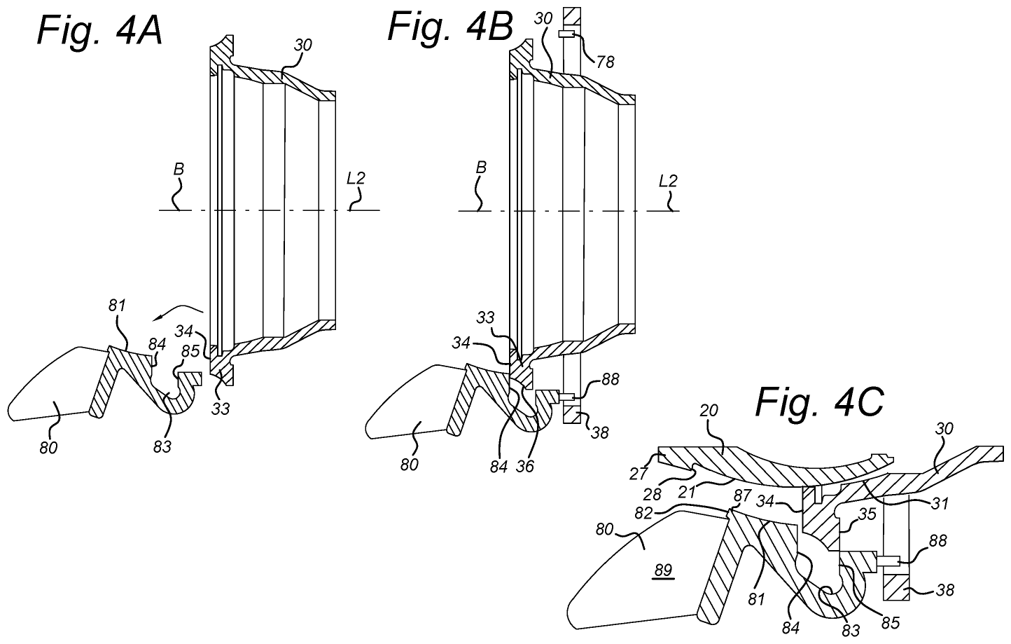

FIG. 4A and 4B schematically show how an outer shell part of the ball joint is axially aligned with a clamp segment of the ball joint

FIG. 4C schematically shows an inner shell part being inserted in the clamp of the ball joint while the outer shell part has already been axially aligned;

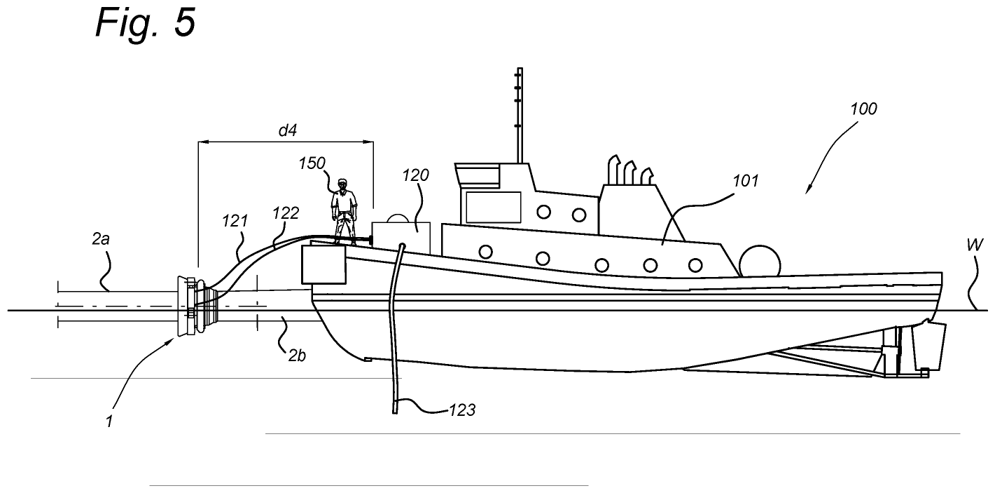

FIG. 5 illustrates how the ball joint according to the invention can be remotely controlled to move the segments between a clamping position and an open position.

### DESCRIPTION OF EMBODIMENTS

FIG. 1A shows an isometric view of a ball joint 1 according to the present invention. The ball joint 1 has a longitudinal centre axis A and comprises an inner shell part 20 and an outer shell part 30 for respective attachment to a first and second pipe, e.g. by means of welding, as well a clamp which comprises a first segment 60, intermediate segment 70 and last segment 80. The segments 60, 70, 80 are shown in FIG. 1A in a clamping position in which movement of the inner shell part 20 relative to the outer shell part 30 along a longitudinal centre line of either of these shell parts is substantially prevented while allowing rotation, e.g. between +15 and −15 degrees or between +5 and −5 degrees, between the respective longitudinal centre lines of these shell parts 20, 30. For driving movement of the segments from the clamping position to an open position and vice versa, the ball joint 1 is further provided with a remote controlled actuator 40 for moving the segments 60, 70, 80 between the shown clamping position and an open position in which the inner shell part 20 and/or the outer shell part 30 can be moved along its longitudinal centre line out of the segments 60,70,80 which form the clamp. The actuator 40 comprises two ports 41, 42 for receiving water from a remote water supply to drive expansion and contraction of the actuator along the longitudinal shaft 43 of the actuator, though instead of water other fluids can be used. As the ball joint 1 according to the invention will generally be used to connect pipes or dredging hoses at sea or at a lake to each other, the remote water supply can advantageously be provided by a pump on a floating platform, such as a dinghy or larger floating platform, wherein the pump is operated to pump water into port 41 or 42 for moving the segments to the clamping or to the open position respectively.

FIG. 1B schematically shows a top view of the ball joint 1 of FIG. 1A, with the segments 60,70,80 in the same clamping position as shown in FIG. 1A. In the embodiment shown, the actuator 40 is pivotably and detachably connected at one end to first segment 60 at pivot shaft S4, and is pivotably and detachably connected at an opposite end to a latch 90 at a pivot shaft S3. The latch 90 comprises a first arm 91 pivotably connected at a first side 91a thereof via pivot shaft S1 to the first segment 60, and a second arm 92 pivotably connected with a first side 92a thereof to a second side 91b of the first arm 91 via the pivot shaft S3. The second arm 92 in turn is pivotably connected at a second side 92b thereof to the last segment 80 at pivot shaft S2, so that when the actuator 40 extends or contracts the segments respectively rotate to the clamping and open position. Once the segments are in the clamping position, the arms of latch 90 can be blocked from moving, e.g. by inserting a pin 95 through arms 91,92, so that the shell parts remain clamped even when the actuator is not powered. Thus, when the latch 90 keeps the segments locked in the clamping position, the actuator 40 may be removed from the ball joint, after which the actuator may be used for driving opening and/or closing of some other ball joint of the same construction. Though not shown, in an alternative embodiment the actuator may instead be fixedly connected to the ball joint, e.g. to reduce the time required for disconnecting two pipes using the joint, as in that case the actuator is already attached. The segments 60,70 are connected to each other by hinge 51, and segments 70 and 80 are connected to each other by hinge 52. The three segments 60,70,80 thus are rotatable relative to each other around pivot points P1 and P2 in a common plane C which extends normal to the centre axis A of the ball joint 1. As the clamp comprises only three segments and the first and last segment are connected to each other by means of the latch 90, the segments 60,70,80 can easily be brought to the clamping position by using the actuator 40 to close the latch 90.

FIG. 1C shows a cross sectional view of the same ball joint of FIG. 1A, but with the segments 60,70,80 in an open position. In comparison with the clamping position shown in FIG. 1A, in the open position the first segment 60 has rotated about 10 degrees around pivot point P1 relative to intermediate segment 70, and the intermediate segment 70 has rotated about 10 degrees around pivot point P2 relative to the last segment 80. In comparison with the clamping position all three segments have translated and rotated in the common plane C away from the longitudinal centre axis A of the ball joint, allowing the inner shell part 20 to be moved out of the clamp along its longitudinal centre line.

FIG. 2 shows a sectional view of the ball joint 1 through line II-II of FIG. 1A. The inner shell part 20 has an spherical outer surface 21 which abuts against a matching inner surface 31 of outer shell part 30. Additionally, matching inner surfaces 71,81 of segments 70 and 80, and also of segment 60 though not shown in FIG. 2, prevent the inner shell part 20 from moving out of the clamp when the segments 60,70,80 are in the clamping position. The spherical outer surface 21 and the matching inner surfaces of the segments and of the outer shell part 30 enable rotation of the inner shell part 20 and the outer shell part 30, and any pipes connected thereto, relative to each other. Flange 27 of the inner shell part is adapted for preventing damage to a pipe attached to the inner shell part when the longitudinal axis L1 of the inner shell part 20 is in a position of maximum rotation relative to the longitudinal axis L2 of the outer shell part 30. In the clamping position shown in FIG. 2 the inner surfaces of the segments 60,70,80, coincide with a circle having a smaller diameter d3 than a largest outer diameter d1 of inner shell part 20 that is arranged in the clamp, preventing the inner shell part 20 from being moved out of the clamp. The inner shell part 20, at its end for connection to a pipe, has an outer diameter d2 which is smaller than said largest outer diameter d1 of the inner shell part. In the open position of the segments, when projected onto the common plane C, the inner surfaces of the segments lie outside of a circle with diameter d1 and a centre point through longitudinal centre line L1 of the inner shell part, so that the inner shell part can be moved out of the clamp.

A circumferential flange 33 of outer shell part 30 is accommodated in accommodation sections of the segments 60, 70,80, so that in the clamping position of the segments shown, the outer shell part 30 cannot be moved out of the clamp. Though FIG. 2 only shows accommodation sections 73,83 of segments 70 and 80, it will be clear that segment 60 comprises an accommodation section of a same construction. The flange 33 has a front surface 34 which faces abutment surfaces 74,84 of the accommodating sections 73, 83, as well as a corresponding abutment surface of the accommodation section of segment 60. In the clamping position shown, the front surfaces 74,84 are substantially prevented from moving axially towards the abutment surfaces by the interfitting of the outer surface 21 of the inner shell part 20 and the matching inner surface 31 of the outer shell part 30. When no inner shell part 20 has been inserted into the clamp (see also FIGS. 4A and 4B), the abutment surfaces prevent the front surfaces from passing the abutment surfaces in a direction towards the first end of the clamp, even when the segments 60,70,80 are in the open position. The outer shell part can thus be easily aligned axially relative to the clamp.

When connecting two shell parts and pipes attached thereto to each other using the ball joint 1, it is highly preferable that that shell part which has the flange is inserted first into the clamp, and secured in a sufficient manner to ensure that the clamp cannot inadvertently fall off the shell part. To achieve this, the outer shell part 30 is provided with a limiting ring fixed 38 thereto and having an inner circumferential surface 39. When neither the inner shell part 20 nor the outer shell part 30 are arranged in the clamp, the actuator 40 is operated to move the segments 60,70,80 in the common plane C such that the flange 33 can be accommodated in the respective accommodation sections 73,83. Subsequently, the actuator 40 is operated such that the accommodation sections 73,83 prevent the flange from being moved out of the clamp, but without the segments 60,70,80 being in the clamping position. Stop elements 78,88 are then attached to the segments 60,70,80 for abutting the inner circumferential surface when the segments are in the open position. Once the stop elements have been installed, the segments can be moved between an open position in which the inner shell part can be moved into and out of the clamp, and a clamping position in which the inner shell part and the outer shell part are clamped by the segments such that relative movement of the shell parts along their longitudinal centre lines Li, L2 is blocked.

The stop elements may for instance be bolts that are screwed into corresponding threaded holes in each of the segments. When the segments are moved to the open position, the bolts are limited from moving radially outward, so that at any time the flange

When the segments 60,70,80 are in the open position and the inner shell part 20 has not yet been inserted into the clamp 50, it is preferable that the inner shell part 20 can be smoothly guided to position in the clamp where the clamp can subsequently be closed. To this end, the segments 60,70,80 are each on their inner sides provided with a guide surface 69,79,89 which slopes towards the centre axis A of the clamp. When the inner shell part 20 comes into contact with one of the guide surfaces 69,79,89 and is pushed substantially along its longitudinal centre line L1 towards the clamp, the spherical outer surface 21 of the inner shell part 22 will eventually come into contact with the matching inner surfaces 71,81 of the segments and with the matching inner surface 31 of the outer shell part 30.

FIG. 3 shows a cross-sectional view of the ball joint 1 of FIG. 2, with two pipes 2a,2b firmly welded at welds 4a,4b respectively to the inner shell part 20 and outer shell part 30 which are held in a clamping position by the clamp segments 60,70,80. The ball joint is further provided with liners 5 on the inner side of the inner shell part and the outer shell part, for protecting these parts from being damaged when a mixture of liquid and solids, such as dredging sludge, is transported there through. For further information on the structure and functioning the liners reference is made to International patent publication no WO 2012/002805 A1 to applicant.

Though the inner shell part 20 and outer shell part 30 are shown with the longitudinal centrelines L1, L2 coinciding with the centre axis B of the clamp 50, the joint allows the inner shell part 20 to rotate with its longitudinal centre line L1 relative to said clamp and to the outer shell part around point R for an angle R in a range of about +15 to −15 degrees.

FIGS. 4A-4C illustrate how the outer shell part 30 and inner shell part 20 can be axially aligned with the clamp. For reasons of clarity, only clamp segment 80 of the clamp is shown these figures, though it will be clear that the clamp also comprises the clamp segments 60 and 70 around its longitudinal centre axis B. FIG. 4A shows the outer shell part 30 in a position spaced apart from the clamp in which the longitudinal centre line L2 of the shell part is roughly aligned with the centre axis B of the clamp and spaced apart from said axis. Preferably the centre line L2 in this position is substantially parallel to the centre axis B, though they may be slightly non-parallel while the shell part and clamp segment remain spaced apart.

In FIG. 4B the outer shell part 30 has been moved toward the clamp in such a manner that the front surface 34 of flange 33 now abuts the abutment surface 84 of segment 80. In this position the front surface 34 will likewise abut corresponding abutment surfaces of segments 60 and 70 so that the outer shell part is aligned with its longitudinal centre line L2 substantially parallel with the centre axis of the clamp B. Once in this position, the segments 70,80 are provided with stop elements 78, 88 which, in combination with limiting ring 38, prevent the clamp from opening to an extent in which it can be slid off the outer shell part 30. With the stop elements attached to the segments and the limiting ring attached to the outer shell part, the segments of clamp can however still be moved in a common plane between an open position for receiving the inner shell part in the clamp, and the clamping position for holding the inner shell part clamped. As long as the segments are not in the closed position, translation of the segments in said common plane remains possible, allowing the segments to be aligned such that the centre axis B of the clamp coincides with the longitudinal centre line L2 during movement of the segments to the closed position.

FIG. 4C shows a portion of the inner shell part 20 as it is moved into the outer shell part 30 and with the clamping segments still in the open position. Once the inner shell part 20 cannot easily be pushed further into the outer shell part 30, the segments are moved to a clamping position resulting in the flange 33 of the outer shell part 30 being accommodated in accommodating sections of the segments. In FIG. 4C only accommodating section 83 of segment 80 is shown though segments 60 and 70 are provided with similar accommodating sections. In the clamping position, axial movement the outer shell part 30 relative to the clamp segments is prevented by abutment of the facing abutment surfaces 84 and 85 of segment 80 with the front surface 34 and oppositely directed back surface 35 of the flange 35 respectively. Likewise, in the clamping position, axial movement of the inner shell part 20 out of the clamp is blocked by inner surface 81 of segment 80, which inner surface matches part of the spherical outer surface 21 of the inner shell part 20, whereas axial movement of the inner shell part further towards the outer shell part is blocked by inner surface 31 of the outer shell part 30, which inner surface matches another part of the spherical outer surface 21.

The flange 27 comprises a circumferential edge 28 which, at least when the clamp is closed, faces a stop surface 82 of segments 80. It will be clear that segments 60 and 70 also comprise such a stop surface. The stop surface 82 extends between a distal edge 87 of the inner surface 81 and the guide surface 89 of the segment 80. When the clamp is closed and the inner shell part is rotated such that circumferential edge 28 abuts the stop surface 82, the edge cannot be moved beyond the stop surface, thus limiting rotation of the inner shell part relative to the outer shell part to the predetermined angle R. The guide surfaces are adapted for spacing the insertion end of the inner shell part, i.e. the distal end of the inner shell part opposite to the flange 27, apart from the stop surface 82 and distal edge 87 as the inner shell part is inserted into the outer shell part in a direction parallel to the clamp's centre axis B. FIG. 5 illustrates a pipe connection assembly 100 comprising a ball joint 1 as described, as well as a first pipe 2a and a second pipe 2b connected thereto. The ball joint 1 is shown connecting dredging hoses, or pipes, 2a, 2b to each other in a substantially water tight manner, wherein the pipes are fixedly attached respectively to an inner shell part and an outer shell part of the ball joint, e.g. as shown in FIG. 3. The ball joint 1 and pipes together contain a sufficient volume of air to keep floating such that they are partially but not completely submerged in the water W. Additionally and/or alternatively the pipes 2a,2b may each be provided with or supported by a floatation body, e.g. in the form of a sleeve which envelops the pipe and is filled with a material lighter than water, preferably air or an air containing foam. The ball joint 1, which also may be provided with or supported by a floatation body such as a rubber bladder, allows the longitudinal axes of the pipes to 2a,2b rotate relative to each other, so that the pipes can sway in conjunction with waves in the water W. A vessel 101 is provided with a pump 120 adapted from pumping water from hose 123 which extends into the sea W, through conduits 121, 122, to corresponding ports 41,42 of the actuator 40 of the ball joint 1, for moving the segments of the clamp to the clamping position or to the open position. The pump 120 is arranged at a distance d4 of at least 5 m from the actuator, and when the pump 120 is controlled by a human operator 150 on the vessel that person is at a safe distance from the inner shell part, outer shell part and clamp of the ball joint.

Once the segments have been moved to the clamping position, the operator 150 can safely move closer to the clamp to lock the segments in place, e.g. by locking the arms of the latch 90 in place using a pin 95 as described herein. Subsequently he may remove the actuator 40 from the ball joint 1 in case the actuator is detachably attached thereto. Next he can detach the conduits 121,122 from the actuator and move the vessel 101, fluid supply 120, and the actuator in case the actuator is detachable, elsewhere.

The present invention has been described above with reference to a number of exemplary embodiments as shown in the drawings. Modifications and alternative implementations of some parts or elements are possible, and are included in the scope of protection as defined in the appended claims.

1. A ball joint (1) for a floating pipe connection, comprising:
an inner shell part (20) and an outer shell part (30) which each define a respective longitudinal centre line (L1, L2) and are rotatable in relation to one another between an aligned position in which the longitudinal centre lines coincide, and a rotated position in which the longitudinal centre lines are at an angle to each other which differs from zero, wherein said outer shell part is adapted for surrounding said inner shell part in a sealing manner with the inner shell part (20) and outer shell part (30) together enclosing a passage which extends from an opening in the inner shell part at one side of the ball joint to an opening in the outer shell part at another side of the ball joint;
a clamp (50) comprising two or more substantially rigid segments (60, 70, 80) moveable between a clamping position in which they clamp the inner and outer shell part such that movement of the inner shell part (20) relative to the outer shell part (30) along either longitudinal centre line is substantially prevented while allowing said rotation of the inner shell part (20) relative to outer shell part (30), and an open position in which one of said shell parts (20, 30) is moveable along its longitudinal centre line (L1, L2) into and out of the clamp (50);
wherein said two or more segments are pivotably connected in series, said series comprising a first segment (60) and an different last segment (80), wherein said segments (60, 70, 80) are moveable relative to each other in a common plane (C) between the open and the clamping position;
wherein the inner shell part (20) has a spherical outer surface (21) for abutting against a matching inner surface (31) of the outer shell part (30), each of said segments (60,70,80) comprising a further matching inner surface (71,81) for abutting against the spherical outer surface (21) of the inner shell part, wherein said matching inner surface and said further matching inner surfaces are adapted for allowing rotation of the inner shell part relative thereto when the segments are in the clamping position while preventing axial movement of the inner shell part along its longitudinal centre line (L1),
wherein each of the segments (60,70,80) is provided on its inner side with a guide surface (69,79,89) for guiding the inner shell part into the clamp, wherein said guide surface slopes from a free distal end of the segment towards the centre axis (B) of the clamp and is completely spaced apart from the segment's inner surface (71,81) that is adapted for abutting against the spherical outer surface (21), wherein the free distal ends of two segments, along a line through the centre axis (B) of the clamp and when the clamp is in the clamping position, are at a distance from each other which is greater than a maximum outer diameter (d1) of spherical outer surface; and
wherein said ball joint is further provided with a remote controlled actuator (40) arranged for driving movement of the two or more segments (60, 70, 80) within said common plane (C) between said clamping position and said open position.

2. Ball joint according to claim 1, wherein the inner shell part is provided with a flange (27) having a circumferential edge (28) for abutting a stop surface (82) of one of said segments when the inner shell part is in a position of maximum rotation with respect to the outer shell part, wherein the stop surface (82) extends between the segment's guide surface (89) and a distal edge (87) of the segment's inner surface (81).

3. Ball joint according to claim 2, wherein the guide surfaces are adapted for spacing the insertion end of the inner shell part, i.e. the distal end of the inner shell part opposite to the flange, apart from the stop surface and distal edge as the inner shell part is inserted into the outer shell part along a direction parallel to the centre axis of the clamp.

4. Ball joint according to claim 1, wherein the guide surfaces of the segments comprise or are made from an elastic material.

5. Ball joint according to claim 4, wherein said elastic material comprises or consists of an elastomer having a Shore A hardness in the range of 70 to 100.

6. Ball joint according to claim 1, wherein each guide surface, when seen in cross-sectional view through a plane parallel to an through the centre axis (B) of the clamp, has a maximum thickness in a plane normal to said centre axis (B) which is two times or more a maximum thickness of the inner shell part along any plane normal to the longitudinal axis of said inner shell part.

7. Ball joint according to claim 1, wherein each guide surface, when seen in cross-sectional view through a plane parallel to and through the centre axis (B) of the clamp, increases in thickness in a direction away from the free end of the corresponding segment.

8. In an embodiment, the guide surfaces each have a length along the centre axis of the clamp that is at least one third of the length of the inner shell part along its longitudinal axis.

9. Ball joint according to claim 1, wherein said two or more segments comprise an intermediate segment (70) that is pivotably connected on one end to the first segment (60) and pivotably connected at an opposite end to the last segment (80).

10. Ball joint according to claim 1, wherein said series of segments, when in the open position, is translatable in the common plane (C) and relative to the shell parts (20,30) when one or both of the shell parts are partially arranged within said plane (C).

11. Ball joint according to claim 1, wherein said two or more segments are pivotably connected in series by means of hinges (51, 52), each hinge connecting two segments in said series, wherein at least one of said hinges (51,52) is moveable in said plane (C) relative to said inner shell part (20) and/or said outer shell part (30) when the segments are in the open position and one or both of the shell parts are partially arranged within said plane (C).

12. Ball joint according to claim 1, wherein said actuator (40) is a fluid powered actuator comprising one or more ports (41, 42) for connection to a fluid supply, in particular a sea-water supply, for powering the actuator to rotate said segments between said clamping position and said open position.

13. Ball joint according to claim 1, wherein said actuator (40) is adapted to be controlled from a distance of at least 2 m from said clamp (50).

14. Ball joint according to claim 1 wherein said clamp (50) further comprises a latch (90) for keeping the segments (60, 70, 80) in the clamping position.

15. Ball joint according to claim 14, wherein said latch (90) comprises a first arm (91) and a second arm (92), wherein said first arm is pivotably connected at a first side (91a) to said first segment (60) and pivotably connected at a second side (91b) to a first side (92a) of said second arm (92), wherein said second arm (92) is pivotably connected at a second side (92b) to said last segment (80), and wherein said actuator (40) is arranged for rotating said first arm (91) relative to said second arm (92) to move the segments (60, 70, 80) between said clamping position and said open position.

16. Ball joint according to claim 1, wherein said actuator (40) is a detachable actuator, and the first and/or the last segment (60,80) is adapted for detachably connecting said actuator thereto.

17. Ball joint according to claim 1, wherein said inner shell part or said outer shell part is provided with a flange (33) and the segments (60,70,80) each comprise an accommodating section (73,83) for accommodating a portion of said flange (33) when the segments are in the clamping position to substantially prevent axial movement of the flange (33) relative to said accommodating sections, and wherein said segments comprise an abutment surface (74,84) adapted for abutting said flange (33) to prevent the flange, when arranged in the clamp, from moving past the accommodating sections when the segments (60, 70, 80) are in the open position.

18. Ball joint according to claim 17, wherein the clamp (50) is further provided with a limiting mechanism (39, 78,88) adapted for limiting movement of the segments to the open position in such a manner that in the open position the clamp cannot be moved past the flange.

19. Ball joint according to claim 18, wherein said limiting mechanism comprises a circumferential limiting surface (39) arranged around and attached to the inner or outer shell part, and further comprises one or more stop elements (78,88) attached to said segments and arranged in a same plane as said circumferential limiting surface (39), wherein movement of the segments to the open position is limited by said stop elements when said stop elements abut said circumferential limiting surface.

20. Ball joint according to claim 17, wherein said segments are substantially free to rotate around the flange when in the open position.

21. Clamp for a ball joint, wherein said ball joint comprises an inner shell part (20) and an outer shell part (30) which each define a respective longitudinal centre line (L1, L2) and are rotatable in relation to one another between an aligned position in which the longitudinal centre lines coincide, and a rotated position in which the longitudinal centre lines are at an angle to each other which differs from zero, wherein said outer shell part is adapted for surrounding said inner shell part in a sealing manner with the inner shell part (20) and outer shell part (30) together enclosing a passage which extends from an opening in the inner shell part at one side of the ball joint to an opening in the outer shell part at another side of the ball joint;
said clamp (50) comprising two or more substantially rigid segments (60, 70, 80) connected in series, said series comprising a first segment (60) and an different last segment (80), wherein said segments (60, 70, 80) are moveable relative to each other in a common plane (C) between a clamping position in which movement of the inner shell part (20) relative to the outer shell part (30) along either longitudinal centre line is substantially prevented while allowing said rotation of the inner shell part (20) relative to the outer shell part (30), and an open position in which one of said shell parts (20, 30) is moveable along its longitudinal centre line (L1, L2) into and out of the clamp (50).

22. Method of connecting a ball joint according to claim 1 to a first pipe and a second pipe, said method comprising the steps of:
moving the segments of the clamp to an open position in which both the inner shell part and the outer shell part can be inserted into the clamp;
arranging said first pipe, with the outer shell part attached to an end thereof, such that said outer shell part is arranged in the clamp;
arranging said second pipe, with the inner shell part attached to an end thereof, such that the inner shell part is arranged in the clamp, with an outer surface of the inner shell part contacting an inner surface of the outer shell part; and
remote controlling the actuator to move the segments to the clamping position.

23. Method according to claim 22, wherein said remote controlling comprises supplying fluid to a port of said actuator, for moving said segments between the open and clamping position.

24. Method according to claim 22, wherein said supplying of fluid is performed by means of a pump that is spaced apart from the ball joint on a floating platform, such as a boat.

25. Method according to claim 22, further comprising, just after arranging the first pipe such that the outer shell part is arranged in the clamp, attaching one or more stop elements to the segments of the clamp for limiting the extent to which the segments can open, such that the outer shell part cannot be moved out of the clamp.

26. Pipe connection assembly comprising a ball joint according to claim 1, further comprising:
a first pipe with an end to which the inner shell part is attached; and
a second pipe with an end to which the outer shell part is attached;
wherein said inner shell part is arranged at least partially within the outer shell part, and wherein said clamp is arranged around said inner and outer shell part.
